(19) United States
(12) Patent Application Publication
(10) Pub. No.: US 2008/0012434 A1
(43) Pub. Date: Jan. 17, 2008

(54) Motor and rotor structure thereof

(75) Inventors: Chen-Mo Jiang, Taoyuan Hsien (TW); Chung-Kai Lan, Taoyuan Hsien (TW); Hung-Chi Chen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/812,038

(22) Filed: Jun. 14, 2007

(30) Foreign Application Priority Data
Jun. 30, 2006 (TW) 095123744

(51) Int. Cl. H02K 1/30; H02K 1/04; H02K 1/27; H02K 1/28

(52) U.S. Cl. 310/43; 310/156.19; 310/156.21; 310/261

(57) ABSTRACT

A rotor structure of a motor includes a shaft, a holding ring, at least one connecting portion and a magnetic element. The holding ring is disposed on and connected with a periphery of the shaft. The connecting portion is disposed at a conjunction of the shaft and the holding ring. The magnetic element is disposed on a periphery of the holding ring.

This Non-provisional application claims priority under 35 U.S.C. §119(a) on Patent Application No(s). 095123744 filed in Taiwan, Republic of China on Jun. 30, 2006, the entire contents of which are hereby incorporated by reference.

### BACKGROUND OF THE INVENTION

1. Field of Invention

The invention relates to a motor and a rotor structure thereof and in particular, to an inner-rotor type motor and a rotor structure thereof.

2. Related Art

Motors function to transform electricity to mechanical energy and are utilized in conjunction with many mechanical structures. Nowadays, there are many kinds of motors available, divided into inner-rotor and outer-rotor types, which have their rotors disposed on the inside or outside of the motors, respectively.

As shown in FIG. 1, a conventional inner-rotor type motor has a rotor structure 1, which mainly includes a shaft 11, an iron center 12 and a magnetic belt 13. The iron center 12 is disposed around the shaft 11. The magnetic belt 13 is disposed around the iron center 12. When the shaft 11 rotates, the iron center 12 and the magnetic belt 13 can be driven to rotate together.

Furthermore, the iron center 12 and the shaft 11 are usually fixed tightly by punching grooves or adhering. When the iron center 12 and the shaft 11 are fixed tightly by punching grooves, it means firstly punching grooves around the shaft 11, and then fixing the iron center 12 tightly to the periphery of the shaft 11 by the punched grooves. However, since the iron center 12 is made of the metal material, there are always small gaps or spaces between the iron center 12 and the shaft 11. After operating for a long time, the iron center 12 may separate from the shaft 11. Alternatively, when the iron center 12 and the shaft 11 are fixed by adhering, the adhesion will degrade after a long period, resulting in the separation of the iron center 12 from the shaft 11.

Therefore, it is an important subject to provide an inner-rotor type motor and a rotor structure thereof, with enhancing bonding between the shaft and the components connected with the periphery of the shaft, and thus further promoting the reliability and efficiency of the motor.

### SUMMARY OF THE INVENTION

In view of foregoing, the invention is to provide an inner-rotor motor and a rotor structure thereof to enhance the bonding between the shaft and the components connected with the periphery of the shaft.

To achieve the above, a rotor structure of an inner-rotor motor according to the invention includes a shaft, a holding ring, at least one connecting portion and a magnetic element. The holding ring is disposed around the shaft. The connecting portion is disposed between the shaft and the holding ring. The magnetic element is disposed around the holding ring.

To achieve the above, an inner-rotor type motor of the invention includes a stator structure and a rotor structure. The rotor structure includes a shaft, a holding ring, at least one connecting portion and a magnetic element. The holding ring is disposed around the shaft. The connecting portion is disposed between the shaft and the holding ring. The magnetic element is disposed around the holding ring.

As mentioned above, the inner-rotor type motor and the rotor structure thereof according to the invention have at least one connecting portion disposed between the shaft and the holding ring, so that the holding ring and the shaft can be tightly fixed to each other by the connecting portion. The connecting portion of the invention can be formed with the shaft or the holding ring as a monolithic piece. That is, the connecting portion can act as a recess or a protrusion on the shaft or the holding ring. Compared with the prior art, the holding ring and the shaft can be fixed more tightly by the connecting portion and hence avoid separation, further promoting the reliability and efficiency.

### BRIEF DESCRIPTION OF THE DRAWINGS

The invention will become more fully understood from the detailed description given herein below illustration only, and thus is not limitative of the present invention, and wherein:

FIG. 1 is a schematic view of the rotor structure of the conventional inner-rotor motor;

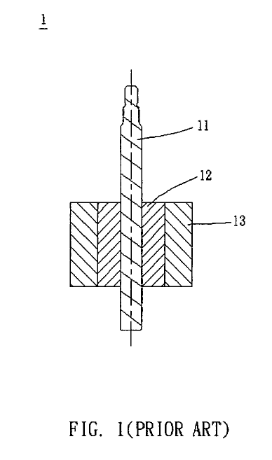

FIG. 2 is a schematic view of the rotor structure of the inner-rotor motor according to a first embodiment of the invention;

FIG. 3 shows various shapes of the connecting portion of the rotor structure of the first embodiment of the invention;

FIG. 4 is a schematic diagram of the rotor structure according a second embodiment of the invention; and

FIG. 5 is a schematic view of the inner-rotor type motor according to the second embodiment of the invention.

### DETAILED DESCRIPTION OF THE INVENTION

The present invention will be apparent from the following detailed description, which proceeds with reference to the accompanying drawings, wherein the same references relate to the same elements.

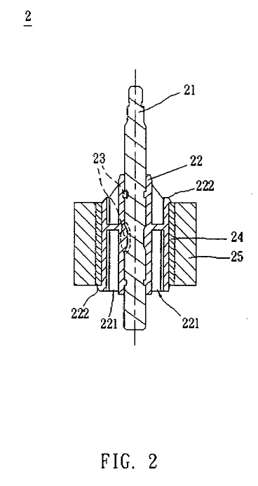

As shown in FIG. 2, a rotor structure 2 of an inner-rotor type motor according to a first embodiment of the invention includes a shaft 21, a holding ring 22 and at least one connecting portion 23.

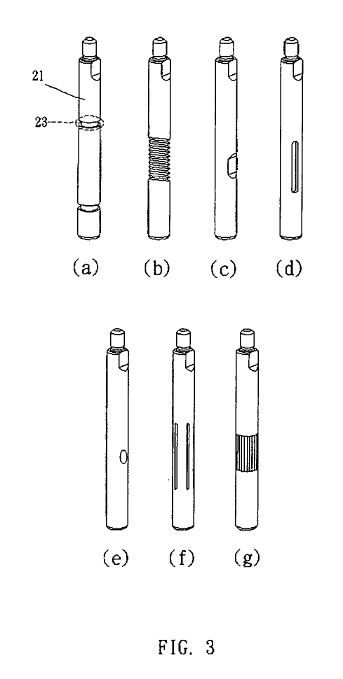

The shaft 21 is the rotating center of the rotor structure 2. When the shaft 21 rotates, the whole rotor structure 2 is driven to rotate together. The shaft 21 can be made of metal, such as a stainless steel. The holding ring 22 is annular, and disposed around the shaft 21. The connecting portion 23 is disposed between the shaft 21 and the holding ring 22 to enhance the bonding between the shaft 21 and the holding ring 22. In the embodiment, the connecting portion 23 is formed with the shaft 21 or the holding ring 22 as a monolithic piece, and can be a recess of the shaft 21 or a protrusion of the holding ring 22. Alternatively, the connecting portion 23 can be a protrusion of the shaft 21 or a recess of the holding ring 22 in this embodiment. Therefore, by the structure of the connecting portion 23, the bonding in the axial and/or lateral direction between the shaft 21 and the holding ring 22 can be strengthened. In the embodiment, the connecting portion 23 can have various shapes, such as a lathe groove (a), a lathe thread (b), a milling plane (c), a milling groove (d), a drilling hole (e), a punching groove (f) or a rolling flower (g) profile at the surface of the shaft 21 as shown in FIG. 3.

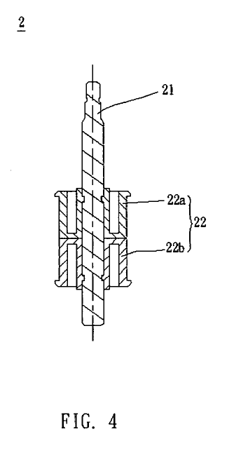

In the embodiment, the holding ring 22 can be connected with the shaft 21 by adhering or wedging. Especially when the holding ring 22 is made of a plasticized nonmetal material, such as a die-casting material or a thermosetting material, the holding ring 22 also can be connected with the shaft 21 by injection-molding. In practice, firstly the shaft 21 is disposed in a mold and then the plasticized nonmetal material is guided into the mold to form the holding ring 22, so that the holding ring 22 can be tightly fixed to the periphery of the shaft 21 with a stronger bonding due to the connecting portion 23. In addition, the holding ring 22 has at least a hollow part 221 which is disposed along the axial direction of the holding ring. Hence, the weight of the rotor structure 2 can be reduced without affecting the bonding, while reducing the cost of material and promoting the reliability and efficiency of the rotor structure 2. As shown in FIG. 4, the holding ring 22 can be composed of at least two parts, for example first and holding rings 22a, 22b.

Referring to FIG. 2 again, the rotor structure 2 further includes a magnetically conductive shell 24. Herein the magnetically conductive shell 24 is an iron shell for magnetic conduction. Please note that using or not using the magnetically conductive shell 24 depends on the requirement of magnetic loop. Furthermore, the end of the holding ring 22 further has at least one hook 222 which is formed with the holding ring 22 as a monolithic piece. The hook 222 can facilitate the connection and provide stronger bonding when the magnetically conductive shell 24 and the holding ring 22 are connected to each other. Therefore, the magnetically conductive shell 24 can be connected with the holding ring 22 by adhering or wedging. Furthermore, the rotor structure 2 further includes a magnetic element 25, such as a magnet or a magnetic belt. The magnetic element 25 is disposed around the magnetically conductive shell 24, so that the magnetically conductive shell 24 is positioned between the holding ring 22 and magnetic element 25.

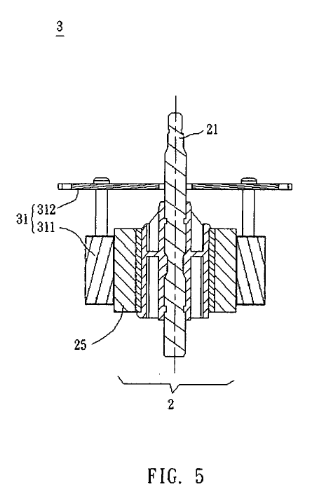

As shown in FIG. 5, an inner-rotor type motor 3 according to a second embodiment of the invention includes a rotor structure 2 and a stator structure 31. The rotor structure 2 is expatiated on in the first embodiment, so the detailed descriptions are omitted.

The stator structure 3 1 includes a magnetically conductive element 311 and a driving device 312. In the embodiment, the magnetically conductive element 311 is disposed around the magnetic element 25 and is opposite to the magnetic element 25. The magnetically conductive element 311 includes at least a silicon steel sheet and at least a winding wound around the silicon steel sheet. The driving device 312 is electrically connected with the magnetically conductive element 311 for controlling the magnetically conductive element 311, especially the current direction of the winding, to produce the magnetic field by which the rotor structure 2 is driven to rotate. In the embodiment, the driving device 312 is a circuit board. Please note that, the stator structure 31 of the embodiment is an aspect only and not the main feature by which the invention is distinguished from the prior art.

As mentioned above, the inner-rotor type motor and the rotor structure according to the invention have at least a connecting portion disposed between the shaft and holding ring, so that the holding ring and the shaft can be tightly fixed to each other. The connecting portion of the invention can be formed with the shaft or the holding ring as a monolithic piece. That is, the connecting portion can act as a recess or a protrusion on the shaft or the holding ring. Compared with the prior art, the holding ring and the shaft can be fixed more tightly by the connecting portion and hence avoid separation. When the holding ring is made of plasticized material, injection-molding can be applied so that the holding ring and the shaft can be tightly fixed to each other. Moreover, the holding ring, the shaft, the magnetically conductive shell and the magnetic element are formed as a monolithic piece by injection-molding. Alternatively, the holding ring, the magnetically conductive shell and the magnetic element can be formed as a monolithic piece by injection-molding and then wedged with the shaft. In this case, the magnetically conductive shell may exist or not depending on the practical needs. In addition, since the specific gravity of the plasticized material is about 1.2, which is much smaller than that of material of the iron center used in the conventional motor, the inner-rotor type motor and the rotor structure of the invention can be reduced in weight, thus enhancing their reliability and efficiency.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A rotor structure applied to a motor, comprising:
a shaft;
a holding ring disposed around the shaft;
at least a connecting portion disposed between the shaft and the holding ring; and
a magnetic element disposed around the holding ring.

2. The rotor structure as recited in claim 1, wherein the connecting portion is formed with the shaft or the holding ring as a monolithic piece.

3. The rotor structure as recited in claim 2, wherein the connecting portion is a recess or a protrusion of the shaft or the holding ring.

4. The rotor structure as recited in claim 3, wherein the recess is a lathe groove, a lathe thread, a milling plane, a milling groove, a drilling hole, a punching groove or a rolling flower profile formed on a surface of the shaft.

5. The rotor structure as recited in claim 1, wherein the holding ring is made of a plasticized nonmetal material, a die-casting material or a thermosetting material.

6. The rotor structure as recited in claim 1, wherein the holding ring is connected with the shaft by adhering, wedging or injection-molding.

7. The rotor structure as recited in claim 1, wherein the holding ring has at least one hollow part disposed along an axial direction of the holding ring.

8. The rotor structure as recited in claim 1, wherein an end of the holding ring has at least one hook and the hook and the holding ring are formed as a monolithic piece.

9. The rotor structure as recited in claim 1, wherein the holding ring is composed of at least two parts.

10. The rotor structure as recited in claim 1, further comprising a magnetically conductive shell disposed between the holding ring and the magnetic element.

11. The rotor structure as recited in claim 10, wherein the magnetically conductive shell is connected with the holding ring by adhering or wedging.

12. The rotor structure as recited in claim 1, wherein the shaft is made of a stainless steel metal, and the magnetic element is a magnet or a magnetic belt.

13. A motor comprising:
a stator structure; and
a rotor structure disposed corresponding to the stator structure and comprising a shaft, a holding ring, at least a connecting portion and a magnetic element, wherein the holding ring is disposed around the shaft, the connecting portion is disposed between the shaft and the holding ring, and the magnetic element is disposed around the holding ring.

14. The motor as recited in claim 13, wherein the connecting portion is formed with the shaft or the holding ring as a monolithic piece.

15. The motor as recited in claim 14, wherein the connecting portion is a recess or a protrusion of the shaft or the holding ring, and the recess is a lathe groove, a lathe thread, a milling plane, a milling groove, a drilling hole, a punching groove or a rolling flower profile formed on a surface of the shaft.

16. The motor as recited in claim 13, wherein the holding ring is made of a plasticized nonmetal material, a die-casting material or a thermosetting material.

17. The motor as recited in claim 13, wherein the holding ring is connected with the shaft by adhering, wedging or injection-molding.

18. The motor as recited in claim 13, wherein the holding ring has at least one hollow part disposed along an axial direction of the holding ring.

19. The motor as recited in claim 13, wherein an end of the holding ring has at least one hook structure, and the hook structure and the holding ring are formed as a monolithic piece.
